(19) United States
(12) Patent Application Publication
(10) Pub. No.: US 2015/0317850 A1
(43) Pub. Date: Nov. 5, 2015

(54) METHOD FOR CONTROLLING ACCESS TO PREMISES BY READING A GRAPHICAL CODE PRESENT ON AN ACCESS TICKET, AND ASSOCIATED COMPUTER SYSTEM AND PROGRAM

(71) Applicant: ALPHA CENTAURI, Colombes (FR)

(72) Inventors: Frederic Buis, Colombes (FR); Eric Le Noc, Le Loroux Bottereau (FR)

(21) Appl. No.: 14/267,725

(22) Filed: May 1, 2014

(51) Int. Cl. G07C 9/00

(52) U.S. Cl. CPC G07C 9/00007

(57) ABSTRACT

A method and apparatus are provided for controlling access to given premises for a user. The method includes a prior step of creating an access ticket giving access to a travel service, the ticket being a reproduced transport ticket enabling this user to make a journey, a graphical identifier being integrated in the access ticket and associated with information making it possible to make the journey when the access ticket reproduced on a medium is read. The method further includes reading the ticket at at least one given premises independently of the journey, and subsequently unlocking an electric door opener triggered by the reading of the graphical identifier reproduced on the medium for allowing access to at least one of the given premises.

### FIELD OF THE DISCLOSURE

The disclosure concerns the field of controlling access to a secure place or at least one dependent on a payment. The disclosure applies more particularly when the user has a ticket for access to a service comprising a graphical code, and the system associates this graphical code with another service such as access to a place.

### BACKGROUND OF THE DISCLOSURE

At the present time, there exist many ways of controlling access to a secure place or a room, access to which is dependent on a payment. These premises are for example a company, a cinema, a hotel, or a private house. Access to such premises is granted if the user has a physical or non-physical access means. The category of non-physical access means includes a code that the user introduces on the Digicode keypad for example. In this case, the user must remember the code whenever he wishes to access the premises, and not forget it. This type of access has another drawback, that of being based on a secret, which can be discovered by unauthorized persons.

It is also possible to access premises by presenting a particular characteristic of the authorized person, and biometric identification of the person is then spoken of. The biometric elements most often used are: fingerprints presented on a suitable reader (touch or visual), voice identification by pronouncing a series of words in front of a microphone, the shape of the face filmed by a camera, the design of the retina, etc. These techniques require the determination of the physical characteristics of authorized persons and referencing them in databases. Biometric data use a large amount of memory space and the reliability of the identification is not always maximum. Thus a person whose voice is hoarse would not be able to enter the secure premises by voice recognition.

At the present time, chip cards are used for many applications and in particular controlling access to premises. The use of such objects affords high security based in particular on the difficulty of reproducing an authentic chip card and/or discovering the secret codes that it contains. This is because the integrated circuit of the card contains a memory, the reading of which is locked by a secure procedure. This secret participates in a cryptographic computation enabling the card reader to check that the card holds the correct secret code. To identify the card carrier, use is generally made of a bearer code that the authorized person is theoretically the only one to know. When the authentication is verified, the system sends a signal to the lock and gives access to the premises. This system requires sharing secrets and regularly updating them by means of secure transfers. Management of such systems is cumbersome and requires expensive equipment. This is because such systems require a homogeneous level of security from the service provider to the user.

In some cases, a limited number of accesses to premises are authorized for a single user, or during a given period of time. It is then not necessary to use a secure access system based on keys stored in modules or chip cards. The user may for example pay for access to the service and receives a code printed on a ticket. The user reads the printed code and enters it on the keypad of the access system. Once the maximum number of accesses is reached, or the authorized duration of access has ended, the code is deleted from the memory of the access system, thus eliminating all subsequent actions. Such a control system requires the printing of a code, which may be lost or recovered by unauthorized persons.

### SUMMARY

An exemplary aspect of the present disclosure relates to a method of controlling access to given premises for a user including a prior step of creating an access ticket giving access to a travel service. The ticket is a reproduced transport ticket enabling this user to make a journey, a graphical identifier being integrated in said access ticket and associated with information making it possible to make said journey when the access ticket reproduced on a medium is read. The method further comprises a step of reading the ticket at at least one given premises independently of the journey, and a subsequent step of unlocking an electric door opener triggered by the reading of said graphical identifier reproduced on a medium for allowing access to at least one of the given premises.

In this way, reading a code triggers access to the premises without human intervention other than that of the occupant of the place.

According to a particular embodiment, the method comprises a step of receiving and reproducing said ticket on a cellphone, and the reading of the ticket on the cellphone then allows access to at least one of the given premises. In this way, the access ticket can be received at any time, and without requiring to be printed.

According to another particular embodiment, the data participating in the creation of the graphical code contain at least characteristics identifying said first service and a data item identifying the user. In this way, the reading of the graphical code allows verification of access and identification of the user.

According to another embodiment, the time during which access is granted to the premises depends on the identity of the user associated with the access ticket. In this way, it is possible to define graphical codes granting access continuously to the premises, to maintenance staff, for example, and other codes that grant access only at certain times, for customers of the premises.

According to another embodiment, the user introduces a command indicating that he is leaving the given premises, and this command triggers the sending of a signal indicating to other persons having permanent authorization that access to said premises is possible. In this way, the maintenance staff (or any other duly authorized staff) is authorized to enter the given premises only if it is unoccupied.

A further aspect of the disclosure relates to a system for controlling access to given premises for a user, comprising a means for creating an access ticket giving access to a travel service. The ticket is a reproduced transport ticket enabling this user to make a journey, a graphical identifier being integrated in said access ticket and associated with information enabling said journey to be made when the reproduced access ticket is read on a medium. The system comprises a control box of an electric door opener placed at at least one given premises independently of the journey, the ticket allowing access to the given premises, said box comprising an optical reader, said box triggers the release of the electric door opener when said graphical identifier reproduced on a medium is read.

According to another physical aspect, the disclosure also concerns a computer program stored on a non-transitory computer-readable medium comprising program code instructions for implementing a step of controlling access to premises included in a method as described above when this program is executed by a processor.

### BRIEF DESCRIPTION OF THE DRAWINGS

Other features and advantages will emerge more clearly from a reading of the following description of a particular embodiment given by way of simple illustrative and non-limitative example, and the accompanying drawings, among which:

FIG. 1 presents a diagram of an access control system in which an embodiment of the disclosure is implemented;

FIG. 2 is an example of a flowchart presenting steps for a particular embodiment of the disclosure;

FIG. 3 shows a table associating the data encoding the graphical code, and the information relating to a second service; and

FIG. 4 presents a message displayed on the screen of a cellphone informing the user that he has access to a second service.

### DETAILED DESCRIPTION OF ILLUSTRATIVE EMBODIMENTS

### General Principle

The general principle of an exemplary embodiment of the disclosure is based on an access control system using an access ticket enabling a user to access given premises. A ticket for access to the given premises is first of all created to authorize for example access to a hotel room, the access ticket comprises a graphical code identifying at least the user. Then the user arrives in front of the door of the given premises and presents the access ticket, which is in paper form or displayed on the screen of a cellphone for example. The access ticket is read by a reader, which compares the graphical code read with a reference code and, in the event of equality, sends a signal to the electric lock in order to unlock the door. The server in return records access to the given premises, identifying the customer as the one authorized to enter these premises.

According to a particular embodiment, the ticket is created in order to grant access to a first service different than the access to the given premises, this first service being for example a journey. The graphical code is associated with the right of access to the given premises and the association information is transmitted to the manager of access to the given place. When the user presents himself at the place delivering this second service, he just needs to show the graphical code to a reader in order to have access thereto. In this way, the access ticket serves for a second use that had not been planned initially.

### DESCRIPTION OF AN EMBODIMENT

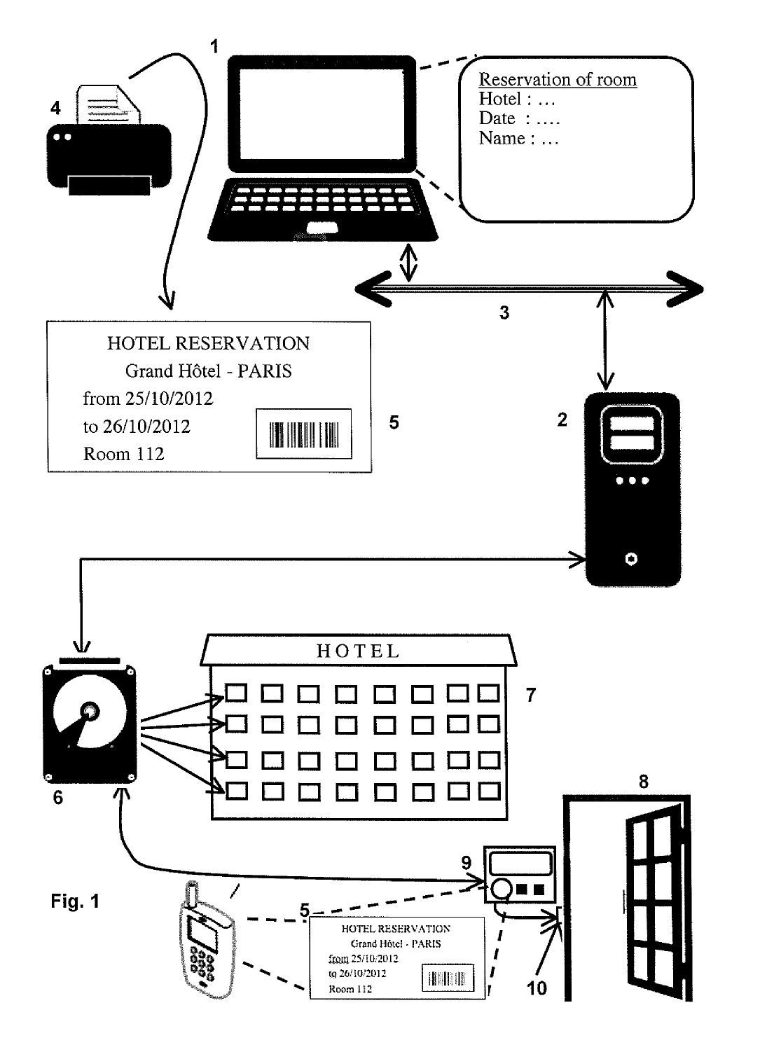

FIG. 1 illustrates a first embodiment of the disclosure in a first access control system, which enables a user to authorize access to premises using an access ticket.

In the example embodiment described here, a user communicates with a hotel room reservation centre by means of his personal computer 1. The screen and keyboard of his computer constitutes the man-machine interface (IHM) enabling him to enter the reservation information such as: the name of the person occupying the room, the name of the hotel, the date and time of arrival, and personalization information such as: the floor, smoker or non-smoker, bathroom or shower, parking, temperature of the room, etc. The computer 1 communicates with a server 2 managing the services and in particular the hotel reservations through a communication network 3, the Internet for example. In some cases, the user is in telephone communication with an operator, who enters the data in the server 2. According to a first variant embodiment, once the reservation is made and optionally paid for, the user can print his access ticket 5 on a printer 4 connected to the computer 1. According to a second variant, the access ticket is non-physical and accessible in the form of a display on the screen of a cellphone. According to an embodiment of the disclosure, the ticket comprises a graphical code, which is typically a barcode, or a QR code. The QR code is a type of two-dimensional barcode consisting of black modules disposed in a square with a white background. There are various codes comprising different numbers of black or white dots ranging from 21 by 21 dots, 25 by 25, 29 by 29 up to 177 by 177. Error correcting codes make it possible to correct reading errors.

The server 2 of the service manager comprises a memory that contains data relating to the services selected by the user, and data personal to the users. In the case of a hotel reservation, the relevant data are:
the address and name of the hotel,
the room number,
the access times,
supplementary information on the service delivered.

The personal data of the user are for example:
cellphone number,
age,
language,
food requirements (kosher, vegetarian), presence of allergy, meal times,
favorite temperature of the hotel room,
favorite television program,
etc.

This information can be obtained at the time of the reservation by means of a questionnaire offered by the user on the screen of the terminal. This information may also be obtained by analyzing the habits of the user during previous reservations.

The server 2 communicates via the network 3 with a plurality of user terminals and by the same network or a different network with at least one at the control server 6 managing accesses to the rooms in the hotel 7 server specified in the reservation. The room is closed by a door, opening of which is controlled by an electronic box 9 and an electric door opener 10. The electronic box 9 contains an interface for communication with the control server 6, and controls the electric door opener 10 for opening and closing. The electronic box 9 comprises a central unit, a data memory, and a user interface consisting of an optical reader (camera or laser reader) and a touch screen. In a variant, the user interface consists of a few keys and a separate screen, or a screen for validating control icons. A variant consists of the screen being a touch screen. The central unit is associated with a program for processing the signals coming from the optical reader, this program being designed in particular to scan graphical codes. The control server 6 can enter into communication with all the electronic boxes 9 controlling access to the premises in the building.

When the user arrives at the selected hotel, he presents the printed access ticket or his cellphone in front of the optical reader controlling entry to the hotel. The optical reader detects the presence of the graphical code reproduced in the ticket and transmits the data to the control server 6. The control server compares the data read with those transmitted by the server 2 and, in the event of equality, transmits a signal unlocking the entrance door. Advantageously, the reader is equipped with a screen that displays a personalized welcome message, indicating the name of the person and his room number. The user then presents himself in front of the door of the room and has the access ticket read by the optical reader of the electronic box 9. The box transmits the data of the graphical code read to the control server 6, which checks in particular whether the user is situated in front of the door of the reserved room. If such is indeed the case, the control server 6 grants access and sends a signal unlocking the electric door opener 10 to the electronic box 9. So the user can enter his room.

### DESCRIPTION OF PARTICULAR EMBODIMENTS

According to a particular embodiment, the ticket is created to grant access to a first service different than the access to the given premises; in this case, the manager of the given premises must recover at one time or another the data of the ticket, and in particular the graphical code. If the user orders a journey and access to a room is included in the journey, then the traveler can immediately inform the control server 6 of this right of access. In the case of a cancelled flight, the graphical code that is reproduced on the ticket is read and associated with a right of access to the given premises, typically a hotel room.

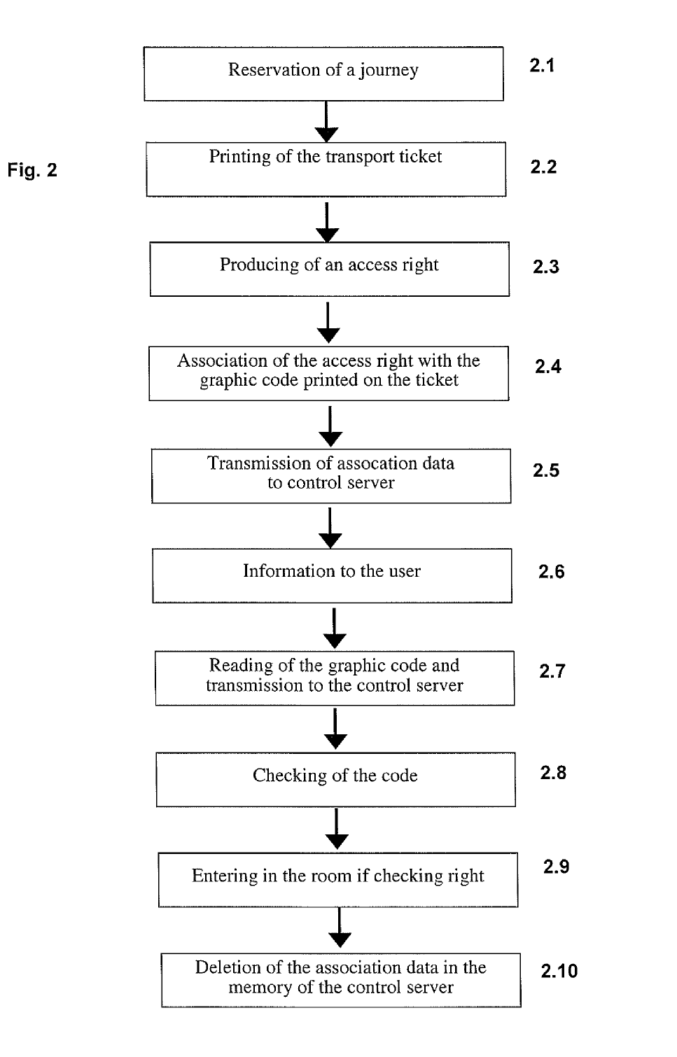

FIG. 2 presents a flow diagram of an embodiment in which the access ticket allows access to a first service different than that of accessing premises.

According to this particular embodiment, a user communicates with the service management server 2 in order to reserve a journey (step 2.1). An example of an itinerary selected by the user is a flight from Nantes to Paris on 25 Oct. 2012 departing at 8 pm, and the identity of the user is Mr M. M. The user validates his journey and the service-managing server 2 records the information describing this, such as:
places of departure and arrival,
departure and arrival times,
user of the journey,
address of the user of the journey,
telephone number of the user of the journey,
email address of the user of the journey,
loyalty card number,
personal data of the user of the journey,
etc.

The server 2 then calculates a graphical code encoding the data identifying the user and the journey selected. This information participating in the calculation of the graphical code is in particular:
point of departure and arrival,
departure and arrival times,
user of the journey.

The graphical code is intended to be an identifier of the first service selected by the user, in this case a journey. The fact that the encoded information comprises data identifying a journey in particular makes it possible not to produce the same graphical code twice. The graphical code (or the data participating in the encoding thereof) and all the information relating to the journey are transmitted to the terminal of the user for printing purposes. At step 2.2, the user prints his transport ticket, which comprises in particular the graphical code such as a QR code. According to a variant embodiment, the user receives the transport ticket in non-physical form in his cellphone.

Then the user goes to the departure point of his journey. He presents himself to the entrance control and presents his transport ticket (either in paper form or displayed on the screen of his cellphone) for a scan of the graphical code. In normal times, the user embarks in the transport means that he has chosen and makes his journey, at the end of which his transport ticket is no longer any use to him. In the context of the present disclosure, the travel company offers the user another service associated with this journey, a free return ticket, or more simply a night in a hotel. This second service may be offered since the flight is delayed, or to recompense the loyalty of the user, or for any other reasons. Likewise, this second service may be granted on several occasions, and this is the case when the transport ticket gives access to a hotel room and to a restaurant, and also makes it possible to open the door to access the parking lot.

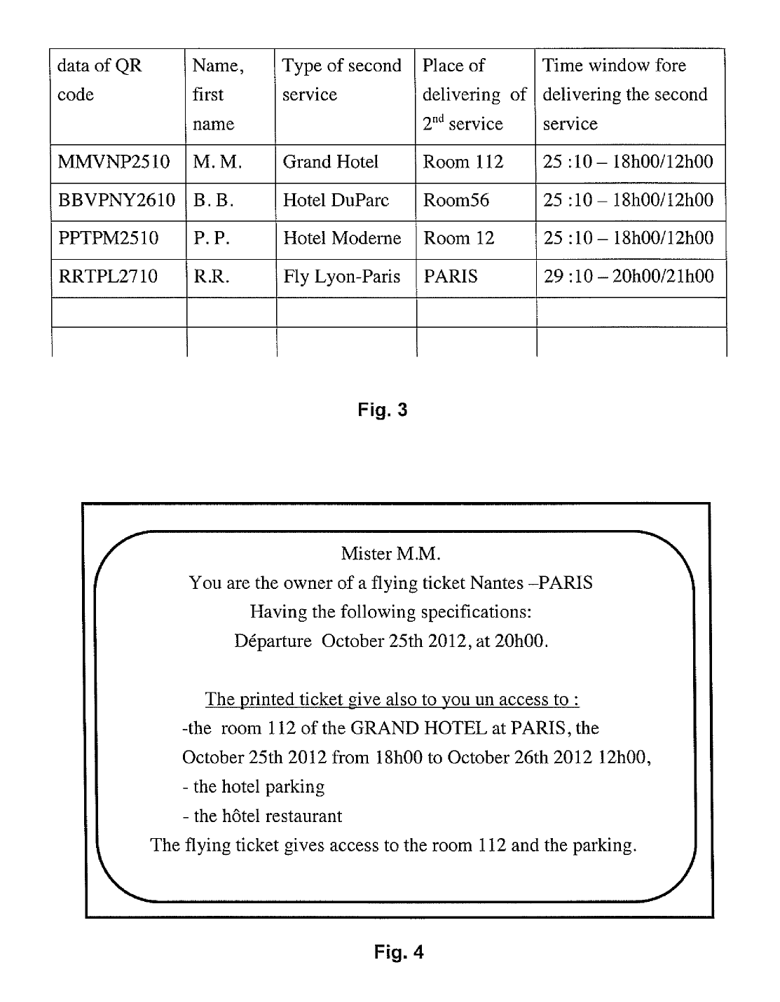

If the user accepts the offer of the travel company, the service-managing server 2 produces a right of access to a certain premises, a hotel room for example, for this user and for a given time window, for example the following night (step 2.3). Then, at step 2.4, the server 2 associates the data of the graphical code printed on the transport ticket with the information defining the right of access to this second service from which the user will be able to benefit. Optionally, the server 2 enters into communication with the control server 6 in order to check the availability of this second service, for example by defining the room number. The server 2 updates in its memory a table associating the data encoding the graphical code, and the information relating to this second service. An example of such a table is shown in FIG. 3. It can be seen in this table that the data of the graphical identifier the data of which are MMVNP2510 (flight Nantes Paris on 25 October the beneficiary of which is Mr M. M.) also gives access to hotel room number 112 of the Grand Hotel for the nights of 25 to 26 October. Likewise, it can be seen that the graphical identifier the data of which are RRTPL2710 (train Paris Lyon 27 October the beneficiary of which is Mr P. P.) also gives access to a Lyon Paris flight on 29 October at 8 pm.

At step 2.5, the server 2 transmits the association data comprising the data of the graphical code and the characteristics of the second service, to the control server 6 managing access to this second service.

The user may be informed by the staff managing the transport means that another service is offered to him.

According to a variant embodiment, the user receives on his cellphone (the number of which is in the memory of the server 2), a message informing him of the elements for finding this service (step 2.6). An example of a message displayed on the screen of a cellphone of the user is shown at FIG. 4. According to this example, these elements are:
the address and name of the hotel,
the room number,
the access times,
the supplementary information on the service delivered.

The user then goes to the place where he can benefit from the service offered and presents his transport ticket in front of the optical reader of the electrical box 9 that delivers the service offered, in this case access to the hotel room offered. At step 2.7, the optical reader detects the presence of a graphical code in front of its lens, scans it and transmits the information to the control server 6. The latter compares the data of the scanned code and the date of the received code (step 2.8) and, in the event of equality, checks that the box that transmitted the information controls access to the room indicated in the association data. In the case of equality, the control server grants access and sends a signal unlocking the electric door opener 10 to the electronic box 9. The user can then enter his room and thus benefit from this second service (step 2.9).

According to an improvement considered as an option, the association data include the time of the start and end of authorization of the second service, typically in the case of a room it is from 6 pm to midday on the next day. When the time of end of authorization has passed, the association data are deleted from the memory of the server (step 2.10). If the second service is one or more other journeys, the time of end of authorization is defined by the dates and times of the last journey. It can thus be seen that the user uses his aircraft or train ticket to open his hotel room in the same way as if he had received a key from the reception of this hotel.

According to a variant embodiment, the control server 6 transmits the association data to the electronic box 9, which delivers the service offered, in this case access to the hotel room offered. In this case, the box 9 compares the code read by the optical reader with the code transmitted by the control server and stored in its memory.

If the user has ordered several transport tickets at the same time for persons accompanying him, the method that is the subject matter of the present disclosure offers several accesses to given premises. The user can thus choose whether he is sharing his room with someone or not. He can also decide that he will have access to all the given premises; this is a case with a parent traveling with this children.

In another embodiment of the disclosure and in the case where the control server 6 manages access to a plurality of premises determined by means of boxes reading the graphical code, each box transmits the data of the codes read to the server. If the user mistakes premises, the control server identifies this user and finds in his memory the premises to which this user has access. In this case, the control server 6 sends, for display on the electronic box 9, a message indicating the number or precise location of the correct premises. The message displayed on the screen of the box that has read the erroneous code is for example:
“This room is not the one selected for you Please go to room 111”

Since the server knows the language of the user who has presented the graphical code, the message is displayed in this language.

If the user presents himself earlier than the time of the start of authorization of the second service specified in the association data, a message informing of this fact is displayed. The message displayed on the screen of the box controlling access to the selected room is of the type:
“This room that is reserved for you will be free only as from 8 pm. Thank you for being patient”

When the user presents himself in front of the selected premises, the control server 6 transmits certain information relating to this user to the various room management systems. For example, the electronic thermostat of the selected room receives the favorite temperature of the user and in this way the latter does not need to manually program the air conditioning system. Likewise, the control server informs the system managing the television sets of the identity of the user and his favorite channel. In this way, the user sees a display window welcoming him and, at the bottom of the screen, the audio-visual program broadcast by his favorite channel.

The access ticket 5 also allows access to services other than that of a given room. If the user has a car that he has indicated to the travel company, the server 2 transmits this information to the control server 6, which grants access to the parking lot when the graphical code of this user is presented in front of the optical reader of the electronic box 9 controlling access to the parking lot. Likewise, the user indicates his presence to the restaurant by presenting his transport ticket in front of a reader. The restaurant check is then associated with this user.

According to a particular embodiment, the electronic box 9 permanently allows access to the room for authorized persons, for example the housekeeping staff.

According to another embodiment, permanent access is subject to the condition that the room is unoccupied. When the box allows the user to access the room, this room becomes occupied and, because of this, the maintenance staff no longer has access thereto. A reader is also disposed inside the room enabling its occupant to release it. A variant consists of the user pressing on a button marked “Exit” placed on or close to the box 9 in order to indicate his departure. On leaving, the box 9 sends a signal to the control server 6 indicating that the chamber is henceforth unoccupied. In this way, the control server can advise the maintenance staff that the room can be cleaned. This information is transmitted by voice message over the cellphone of the staff or by text message. The maintenance staff has badges comprising QR codes that are read by the boxes 9. At each reading, the box transmits the data to the control server 6, which thus checks that these data correspond to those of maintenance staff. In this way, the control server is informed continuously of the occupation of each room and can manage maintenance thereof in optimum fashion.

Advantageously, the box 9 has a menu and keys enabling the user who leaves the room to trigger the checkout and thus to minimize the times needed for the checkout operations.

Conventional techniques making it possible to give access to premises are ill suited when the right of access is granted only occasionally, or requires manual control. An exemplary embodiment of the present disclosure offers a solution better suited to this type of circumstance.

The system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor and stored on a non-transitory computer-readable media such as but not limited to read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media is readable by the computer, stored in the memory, and executed by the processor. For example one or more parts of the system may be implemented by a computer processor with associated memory and timing circuitry (not separately shown) that is a functional part of the system and is activated by, and facilitates functionality of other components or parts of the system.

The present disclosure may be described in terms of functional block components and various processing steps. Such functional blocks may be realized by any number of hardware and/or software components that perform the specified functions. For example, embodiments of the present disclosure may employ various integrated circuit components, e.g., memory elements, processing elements, logic elements, look-up tables, and the like, which may carry out a variety of functions under the control of one or more microprocessors or other control devices. Similarly, where the elements of various aspects of the present disclosure are implemented using software programming or software elements the aspects of the present disclosure may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, aspects of the present disclosure could employ any number of conventional techniques for electronics configuration, signal processing and/or control, data processing and the like.

Although the present disclosure has been described with reference to one or more examples, workers skilled in the art will recognize that changes may be made in form and detail without departing from the scope of the disclosure and/or the appended claims.

1. A method of controlling access to given premises for a user, comprising:
a prior step of creating an access ticket giving access to a travel service, said ticket being a reproduced transport ticket enabling this user to make a journey, a graphical identifier being integrated in said access ticket and associated with information making it possible to make said journey when the access ticket reproduced on a medium is read; and
a step of reading said ticket at at least one given premises independently of the journey, and a subsequent step of unlocking an electric door opener triggered by the reading of said graphical identifier reproduced on the medium for allowing access to at least one of the given premises.

2. The method for controlling access to premises according to claim 1; wherein the method comprises a step of receiving and reproducing said ticket on a cellphone, reading of the ticket on the cellphone allowing access to at least one of the given premises.

3. The method according to claim 1, wherein the step of creating an access ticket comprises creating the graphical identifier based at least on characteristics identifying said travel service and a data item identifying the user.

4. The method according to claim 1, comprising granting access to the premises for a time during that depends on the identity of the user associated with the access ticket.

5. The method according to claim 1, wherein the method comprises a step of introduction of a command by the user indicating that the user is leaving the given premises, said introduction step triggering a sending of a signal indicating to other persons having permanent authorization that access to said premises is possible.

6. A system for controlling access to given premises for a user comprising:
means for creating an access ticket giving access to a travel service, said ticket being a reproduced transport ticket enabling this user to make a journey, a graphical identifier being integrated in said access ticket and associated with information enabling said journey to be made when the reproduced access ticket is read on a medium;
a control box of an electric door opener placed at at least one given premises independently of the journey, the ticket allowing access to the given premises, said box comprising an optical reader, said box triggering a release of the electric door opener when said graphical identifier reproduced on the medium is read.

7. At least one non-transitory computer-readable memory comprising program code instructions stored thereon for implementing 6 method of controlling access to given premises for a user when the program code instructions are executed by at least one processor, wherein the method comprises:
creating an access ticket giving access to a travel service, said ticket being a reproduced transport ticket enabling this user to make a journey, a graphical identifier being integrated in said access ticket and associated with information making it possible to make said journey when the access ticket reproduced on a medium is read; and
reading said ticket at at least one given premises independently of the journey, and subsequently unlocking an electric door opener triggered by the reading of said graphical identifier reproduced on the medium for allowing access to at least one of the given premises.
